(19) United States
(12) Patent Application Publication
(10) Pub. No.: US 2024/0199875 A1
(43) Pub. Date: Jun. 20, 2024

(54) COMPOSITIONS AND PROCESSES FOR THE PRODUCTION OF SUB-MICRON POLYMER PARTICLES

(71) Applicant: SOLVAY SPECIALTY POLYMERS USA, LLC, Alpharetta, GA (US)

(72) Inventors: Kelly D. Branham, Woodstock, GA (US); Sarah Howard, Roswell, GA (US); Nancy J. Singletary, Alpharetta, GA (US)

(73) Assignee: SOLVAY SPECIALTY POLYMERS USA, LLC, Alpharetta, GA (US)

(21) Appl. No.: 18/556,296

(22) PCT Filed: Mar. 31, 2022
(86) PCT No.: PCT/EP2022/058718

§ 371 Date: Oct. 19, 2023

Related U.S. Application Data
(60) Provisional application No. 63/176,527, filed on Apr. 19, 2021.

(51) Int. Cl. C08L 71/10; C08J 3/12; C08J 3/20; C08K 5/09; C08K 5/42; C08L 81/00

(52) U.S. Cl. CPC C08L 71/10; C08J 3/12; C08J 3/201; C08K 5/09; C08K 5/42; C08L 81/00; C08J 2371/10; C08J 2381/00

(57) ABSTRACT

The present disclosure relates to compositions containing a) at least one thermoplastic polymer, b) at least one small molecule organic salt, and c) at least one water-soluble or water-dispersible polymer, including processes for the use thereof for the production of polymer particles of sub-micron size.

### CROSS REFERENCE TO RELATED APPLICATIONS

This application claims priority to U.S. provisional patent application No. 63/176,527, filed on Apr. 19, 2021, which is incorporated herein by reference.

### FIELD OF THE INVENTION

The present invention relates to the field of compositions comprising: a) at least one thermoplastic polymer, b) at least one small molecule organic salt, and c) at least one water-soluble or water-dispersible polymer, including processes for the use thereof for the production of polymer particles of sub-micron size.

### BACKGROUND

Coatings and varnishes for various applications are vast and diverse. Some applications of coatings include interior and exterior house paints, interior furnishings, glass and façade coatings for high-rise buildings, many types of transportation vehicles and structures, such as automobiles, airplanes, bridges, road markings, marine vessels, spacecraft, and the like, as well as a wide variety of industrial and non-industrial maintenance coatings. At a smaller scale, coatings are used in kitchen implements, such as cookware, and in numerous electronic products, including consumer and industrial electronics, and biomedical products. Coating layer thicknesses can vary widely depending on the application. For example, an anti-skid coating on the deck of an aircraft carrier may be on the order of hundreds of micrometers while insulating coatings for microchips may be on the order of less than a micrometer. Coatings play one or more key roles in such applications, such as improving a product's aesthetic appeal, protecting a substrate from a wide range of abuses (e.g., damage due to scratches or impact, corrosion, long term weathering, and bio-fouling), and providing specialized functionality to a product (e.g., conductivity, insulation, water repellency, and heat reflection). However, the existence of a vast range of products and structures having such coatings continue to present performance challenges as the market pushes for improved performance attributes, such as better corrosion and chemical resistance in industrial coatings and paints, better scratch-resistant coatings for cookware and other surfaces, and thinner low Dₖ/D_{f} coatings for electronics applications, to name a few.

Oftentimes, the performance characteristics of a coating or a varnish depends on the particle size of one or more components contained therein. For example, some properties of paint, such as stability and weather resistance, depend on the particle size of the pigment in the paint. For instance, reduced pigment particle size increases pigment surface area, which usually results in increased viscosity. Higher viscosity or induced thixotropy prevents pigment mobility, preventing both settling and reflocculation. In addition to package stability, the stability of the cured film, or the performance of the coating after it has been applied and cured, can be affected by pigment particle size. In the case of coatings used for lubricant applications, viscosifiers are often used. Viscosifiers having very small particle size would provide the benefit of higher mass efficiency as lesser amounts would be needed to obtain desirable lubrication performance. Thin films and conformal coatings used, for example, in electronic applications often contain particles imparting specialized functionality, such as low dielectric constant. Since coating thickness is often limited by such particles that impart specialized functionality, smaller particle sizes would allow for thinner films and thinner conformal coatings.

Various approaches are known for producing particles of very small size, such approaches being top-down approaches in which larger particles are reduced in size by, for example, grinding, or bottom-up approaches in which particles of small size are chemically synthesized directly by, for example, emulsion polymerization. However, challenges continue to exist for the production of particles of very small size, i.e., sizes on the order of a few microns or less.

Therefore, there is an ongoing need for new and improved compositions and processes for the production of particles of very small size, typically sizes on the order of a few microns or less. Herein, compositions and processes used for the production of particles have an average size of less than 2 μm, typically less than 1 μm, such as 0.1 to 1 μm, are described.

### SUMMARY OF THE INVENTION

This objective, and others which will become apparent from the following detailed description, are met, in whole or in part, by the compositions, methods and/or processes of the present disclosure.

In a first aspect, the present disclosure relates to a composition comprising:
a) at least one thermoplastic polymer,
b) at least one small molecule organic salt, and
c) at least one water-soluble or water-dispersible polymer.

In a second aspect, the present disclosure relates to a process for preparing particles comprising a thermoplastic polymer, wherein the particles have an average size of less than 2 μm, typically less than 1 μm, such as 0.1 to 1 μm, the process comprising:
a) melt-blending a composition described herein,
b) processing the melt-blended composition obtained in step a) into pellets or strands,
c) cooling the pellets or strands obtained in step b),
d) contacting the cooled pellets or strands obtained in step c) with water, typically hot water, more typically water at a temperature of from 50 to 100° C., thereby forming the particles comprising the thermoplastic polymer.

In a third aspect, the present disclosure relates to a collection of particles each comprising at least one thermoplastic polymer, wherein the particles have an average size of less than 2 μm, typically less than 1 μm, such as 0.1 to 1 μm, and a BET surface area of from 5 to 15 m²/g, typical from 5 to 8 m²/g.

In a fourth aspect, the present disclosure relates to a dispersion comprising a collection of particles described herein, at least one surfactant, and a liquid medium.

In a fifth aspect, the present disclosure relates to a process for preparing a dispersion, the process comprising mixing a collection of particles prepared according to a process described herein or a collection of particles each comprising at least one thermoplastic polymer, wherein the particles have an average size of less than 2 μm, typically less than 1 μm, such as 0.1 to 1 μm, and a BET surface area of from 5 to 15 m²/g, typical from 5 to 8 m²/g, with at least one surfactant, and a liquid medium.

### BRIEF DESCRIPTION OF THE FIGURES

FIG. 1 shows inventive particles made from PEEK polymer according to the present disclosure.

FIG. 2 shows inventive particles made from PPS polymer according to the present disclosure.

FIG. 3 shows inventive particles made from LCP according to the present disclosure.

FIG. 4 shows particle size distributions for the dispersions made according to the present disclosure.

### DETAILED DESCRIPTION

As used herein, the terms “a”, “an”, or “the” means “one or more” or “at least one” and may be used interchangeably, unless otherwise stated.

As used herein, the term “and/or” used in a phrase in the form of “A and/or B” means A alone, B alone, or A and B together.

As used herein, the term “comprises” includes “consists essentially of” and “consists of.” The term “comprising” includes “consisting essentially of” and “consisting of.” “Comprising”, which is synonymous with “including,” “containing,” or “characterized by,” is intended to be inclusive or open-ended and does not exclude additional, unrecited elements or steps. The transitional phrase “consisting essentially of” is inclusive of the specified materials or steps and those that do not materially affect the basic characteristic or function of the composition, process, method, or article of manufacture described. The transitional phrase “consisting of” excludes any element, step, or component not specified.

Unless defined otherwise, all technical and scientific terms used herein have the same meaning as is commonly understood by one of skill in the art to which this specification pertains.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

Throughout the present disclosure, various publications may be incorporated by reference. Should the meaning of any language in such publications incorporated by reference conflict with the meaning of the language of the present disclosure, the meaning of the language of the present disclosure shall take precedence, unless otherwise indicated.

The term and phrases “invention,” “present invention,” “instant invention,” and similar terms and phrases as used herein are non-limiting and are not intended to limit the present subject matter to any single embodiment, but rather encompasses all possible embodiments as described.

It should be noted that in specifying any range of concentration, weight ratio or amount, any particular upper concentration, weight ratio or amount can be associated with any particular lower concentration, weight ratio or amount, respectively.

The compositions and processes described herein allow the production of sub-micron particles composed of polymeric materials, typically thermoplastic materials.

The first aspect of the present disclosure relates to a composition comprising:
a) at least one thermoplastic polymer,
b) at least one small molecule organic salt, and
c) at least one water-soluble or water-dispersible polymer.

The composition comprising a) at least one thermoplastic polymer, b) at least one small molecule organic salt, and c) at least one water-soluble or water-dispersible polymer has been found to be useful for the production of polymer particles, typically thermoplastic polymer particles, of sub-micron size. Component a), which is the at least one thermoplastic polymer, is the material of which particles are to be made and components b) and c) make up the “carrier phase”.

The at least one thermoplastic polymer may be any thermoplastic polymer known to those of ordinary skill in the art and is not particularly limited. Suitable thermoplastic polymers include, but are not limited to, polymers selected from the group consisting of liquid crystal polymers (LCP), polyamides (PA), polyimides (PI), polyarylether ketones (PAEK), polyamide-imides (PAI), polyarylene sulfides (PAS), polyarylether sulfones (PAES), fluoropolymers (FP), and combinations thereof.

In an embodiment, the at least one thermoplastic polymer is selected from the group consisting of liquid crystal polymers (LCP); polyarylether ketones (PAEK), typically polyetherether ketone (PEEK) or polyetherketone ketones (PEKK); polyarylene sulfides (PAS), typically polyphenylene sulfide (PPS); and combinations thereof.

LCPs are generally the reaction product of at least one dicarboxylic acid and at least one diol and are, thus, polyesters. In some embodiments, the polyesters are formed from the reaction product of at least one dicarboxylic acid, at least one diol, and at least one hydroxycarboxylic acid.

Suitable LCPs are at least partially aromatic polyesters. In some embodiments, the LCPs are wholly aromatic polyesters.

Aromatic dicarboxylic acid, diols, and hydroxycarboxylic acids are suitable for forming liquid crystalline polyesters according to embodiments of the present disclosure. Suitable liquid crystal polymers comprise one or more of the following structural units, which are derived from the corresponding aromatic dicarboxylic acids, aromatic diols, or aromatic hydroxycarboxylic acids:

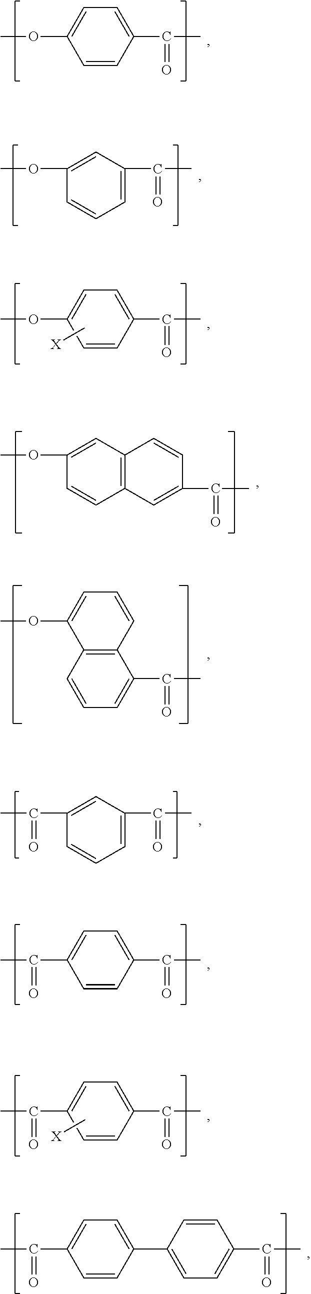

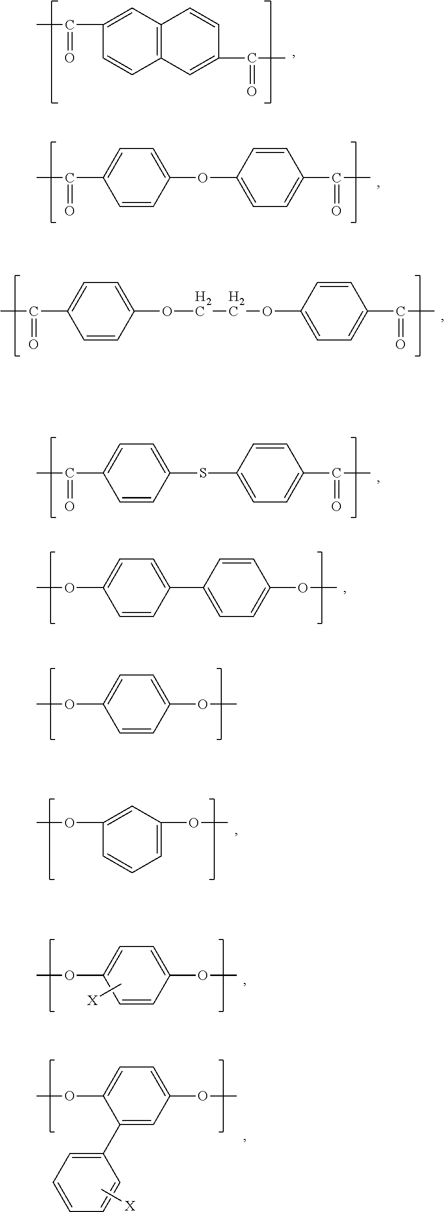

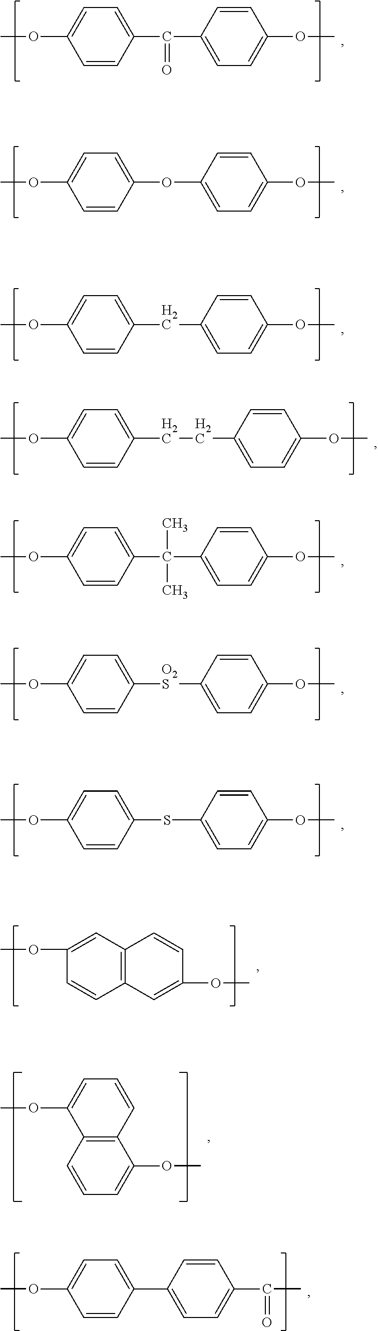

wherein X at each occurrence is halogen, alkyl, or aryl.

In an embodiment, the liquid crystal polymer comprises one or more structural units selected from the group consisting of:

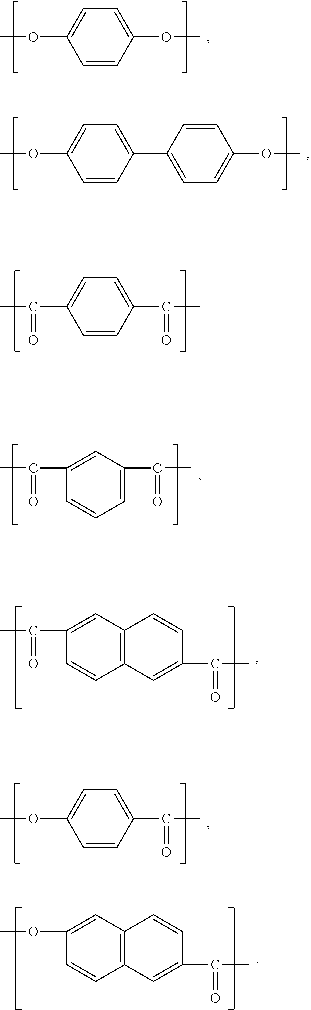

In some embodiments, the LCP is formed from at least one dicarboxylic acid selected from the group consisting of terephthalic acid, isophthalic acid, 2,6-naphthalic dicarboxylic acid, 3,6-naphthalic dicarboxylic acid, 1,5-naphthalic dicarboxylic acid, 2,5-naphthalic dicarboxylic acid, and at least one diol selected from the group consisting of hydroquinone, resorcinol, 4,4′-biphenol, 3,3′-biphenol, 2,4′-biphenol, 2,3′-biphenol, 3,4′-biphenol, and isomers of dihydroxynaphthalene, such as 1,4-dihydroxynaphthalene, 1,5-dihydroxynaphthalene, 2,3-dihydroxynaphthalene, 2,7-dihydroxynaphthalene, and 2,6-dihydroxynaphthalene.

In another embodiment, the LCP is formed from hydroxycarboxylic acid monomers selected from the group consisting of p-hydroxybenzoic acid, m-hydroxybenzoic acid, 2,6-hydroxynaphthalic acid, 3,6-hydroxynaphthalic acid, 1,6-hydroxynaphthalic acid, and 2,5-hydroxynaphthalic acid.

The LCP may also comprise a non-aromatic dicarboxylic acid, a non-aromatic diol, and/or a non-aromatic hydroxycarboxylic acid in addition to or in place of those described hereinabove. For example, suitable dicarboxylic acids for use in forming the LCP are cycloaliphatic dicarboxylic acids and isomers thereof, for example, 1,3-cyclohexanedicarboxylic acid and 1,4-cyclohexanedicarboxylic acid.

In some cases, the LCP may comprise amide functional groups. Amine-functionalized and amide-functionalized monomers, such as 4-aminophenol and 4-acetamidophenol, are suitably used to form the LCP.

In some embodiments, the LCP comprises up to about 50 mole % terephthalic acid structural units, up to about 30 mole % isophthalic acid structural units, and up to about 50 mole % biphenol structural units.

In other embodiments, the LCP comprises from about 5 mole % to about 30 mole % terephthalic acid structural units, up to about 20 mole % of isophthalic acid structural units, and from about 5 mole % to about 30 mole % biphenol structural units.

In some embodiments, the LCP further comprises from about 5 mole % to about 40 mole % hydroquinone structural units. In other embodiments, about 5 mole % to about 35 mole % 2,6-naphthalic dicarboxylic acid structural units are additionally present.

In an embodiment, the LCP further comprises from about 40 mole % to about 70 mole % of p-hydroxybenzoic acid structural units. In another embodiment, the LCP further comprises from about 15 mole % to about 30 mole % of 2,6-hydroxynaphthalic acid.

In some embodiments, the LCP is formed by polymerizing a mixture of aromatic monomers consisting of terephthalic acid, isophthalic acid, p-hydroxybenzoic acid, and biphenol. In an embodiment, the LCP is formed by polymerizing a mixture of aromatic monomers consisting of terephthalic acid, p-hydroxybenzoic acid, and biphenol. In another embodiment, the LCP is formed by polymerizing a mixture of aromatic monomers consisting of terephthalic acid, p-hydroxybenzoic acid, biphenol, and hydroquinone.

Suitable LCPs may be synthesized according to methods known to those of ordinary skill in the art or may be obtained from commercial sources. For example, suitable LCPs include XYDAR® SRT-300, SRT-400, SRT-700, SRT-900, and SRT 1000 liquid crystalline polymers available from Solvay Specialty Polymers USA, LLC.

Suitable PAEK polymers are those in which more than 50% by moles of the recurring units of said PAEK polymer are recurring units (R_{PAEK}) comprising a Ar—C(O)-Ar′ group, with Ar and Ar′, equal to or different from each other, being aromatic groups. The recurring units (R_{PAEK}) are generally selected from the group consisting of formulae (J-A) to (J-O), herein below:

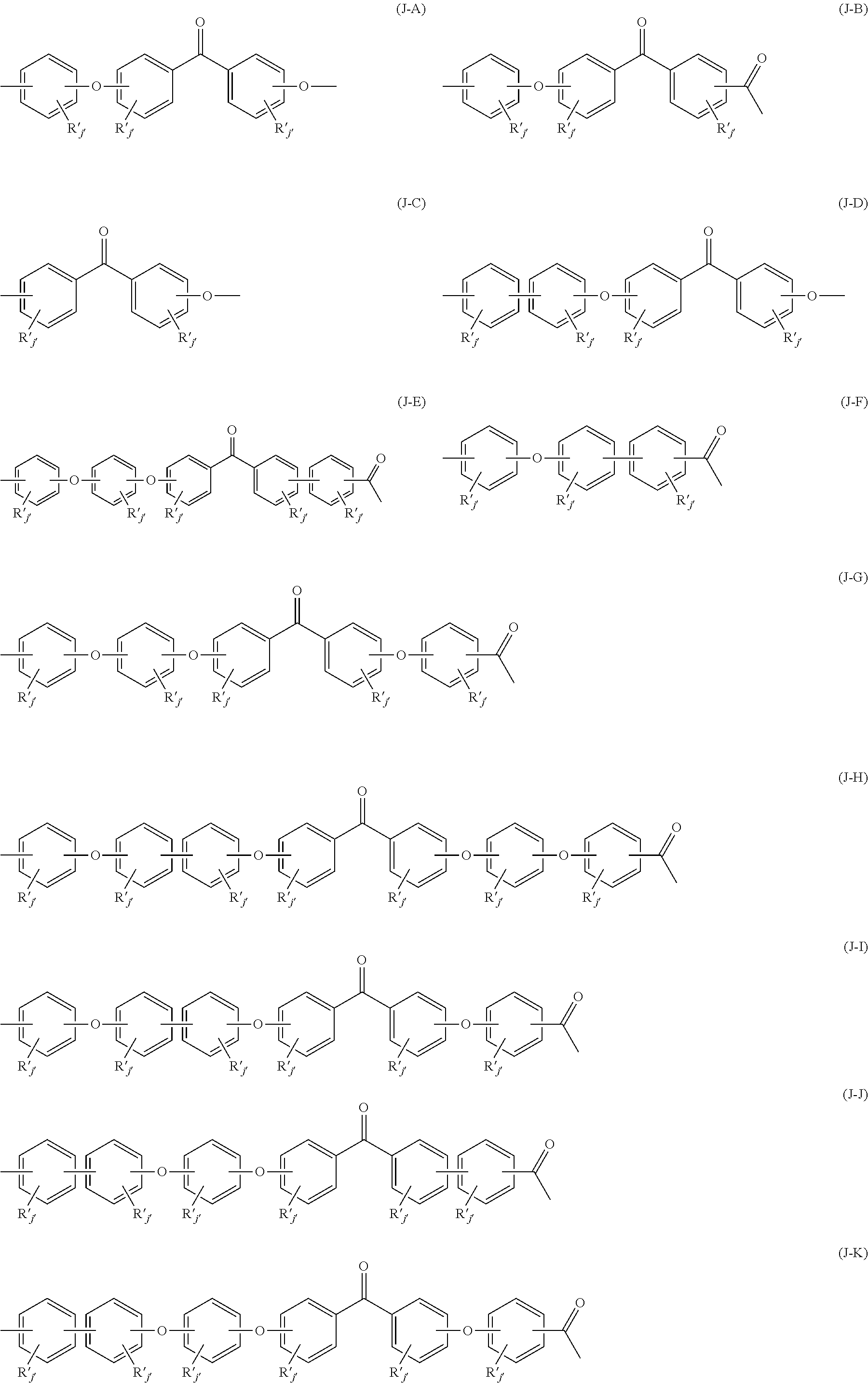

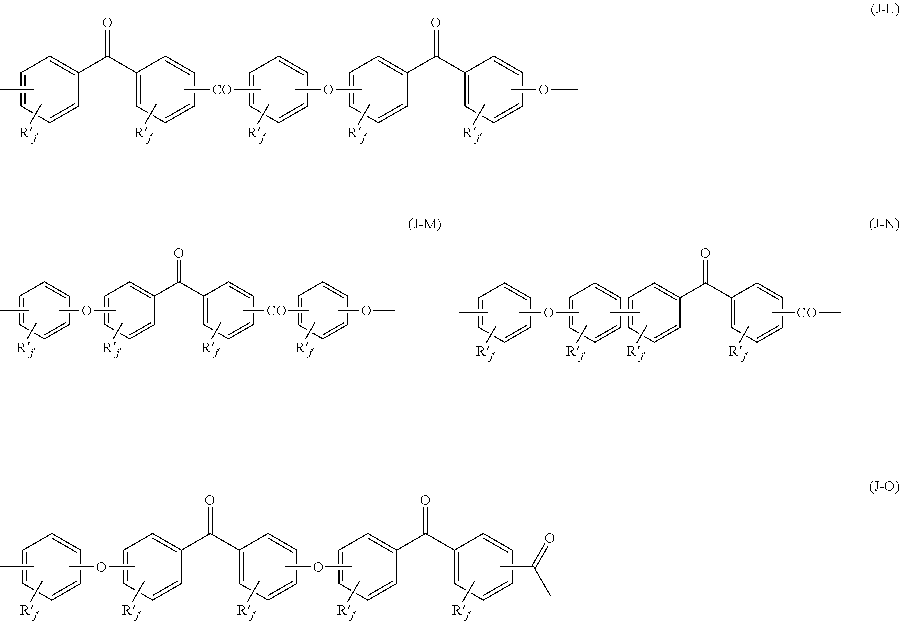

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium, and j is zero or is an integer from 0 to 4.

In recurring units R_{PAEK}, the respective phenylene moieties may independently have 1,2-, 1,4- or 1,3-linkages to the other moieties different from R′ in the recurring unit. Typically, the phenylene moieties have 1,3- or 1,4-linkages, more typically they have 1,4-linkage.

In some embodiments, j′ is typically at each occurrence zero, that is to say that the phenylene moieties have no other substituents than those enabling linkage in the main chain of the polymer.

In an embodiment, recurring units R_{PAEK} are selected from those of formulae (J′-A) to (J′-O) herein below:

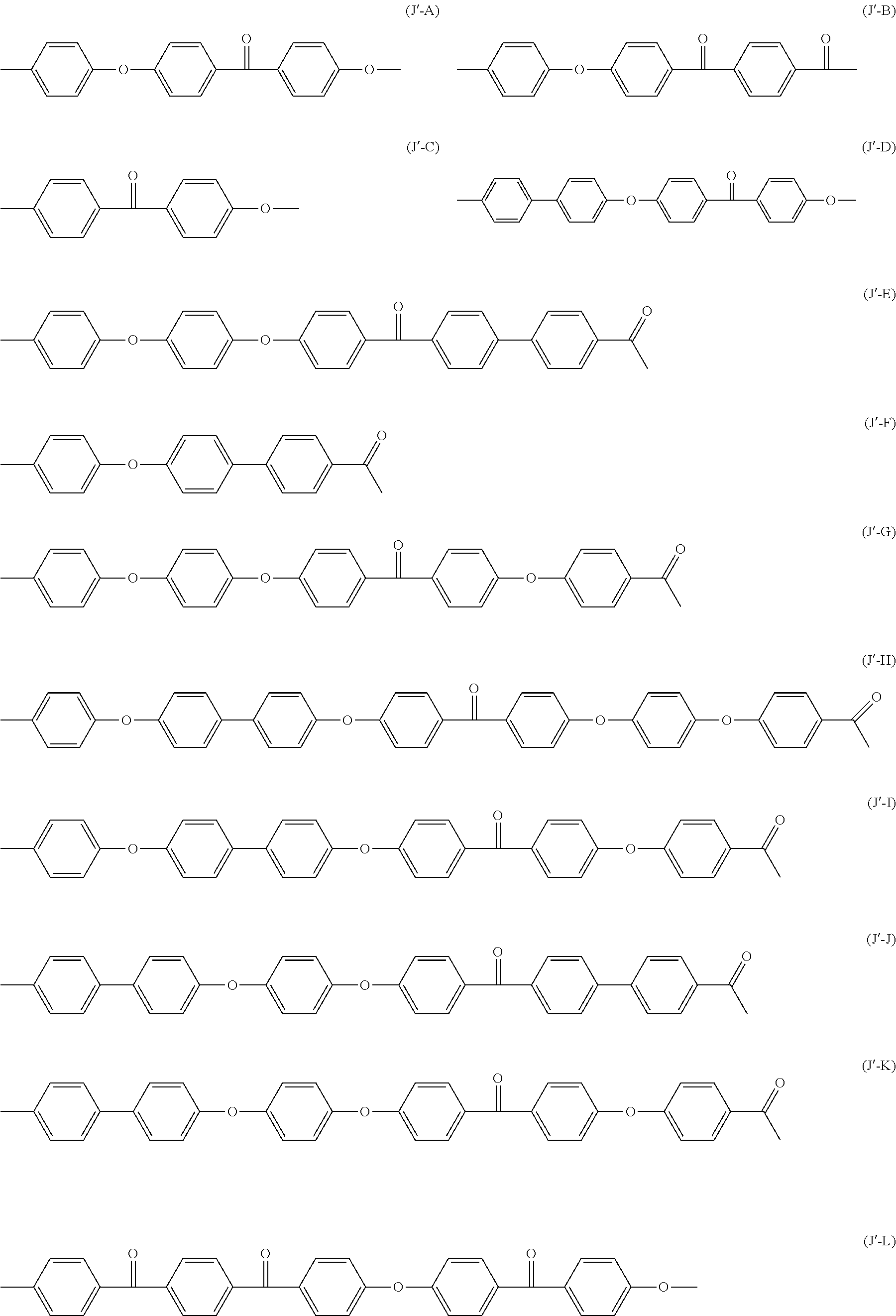

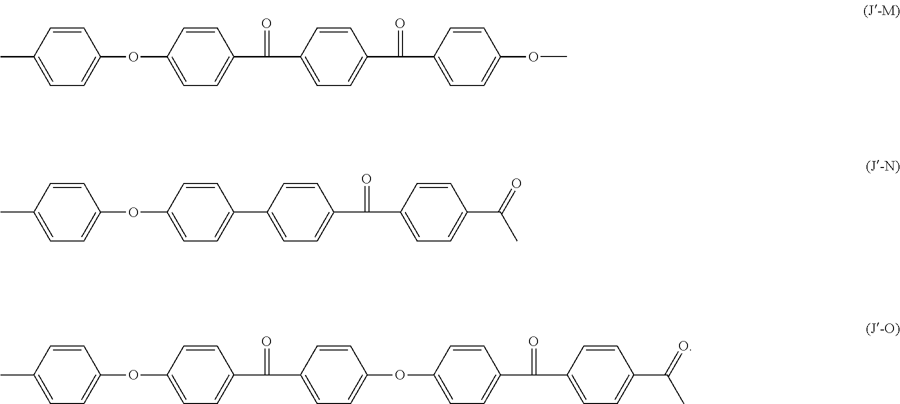

In an embodiment, more than 60% by moles, typically more than 80% by moles, more typically more than 90% by moles of the recurring units are recurring units R_{PAEK}.

In an embodiment, substantially all recurring units of the PAEK polymer are recurring units R_{PAEK}; chain defects, or very minor amounts of other units might be present, being understood that these latter do not substantially modify the properties of the PAEK polymer.

The PAEK polymer may be a homopolymer, a random, alternate or block copolymer. When the PAEK polymer is a copolymer, it may notably contain (i) recurring units R_{PAEK} of at least two different formulae chosen from formulae (J-A) to (J-O), or (ii) recurring units R_{PAEK} of one or more formulae (J-A) to (J-O) and recurring units R*PAEK different from recurring units R_{PAEK}.

In an embodiment, the PAEK polymer may be a polyetheretherketone polymer PEEK) polymers. In another embodiment, the PAEK polymer may be a polyetherketoneketone polymer PEKK polymer.

For the purpose of the present invention, the term “PEEK polymer” is intended to denote any polymer of which more than 50% by moles of the recurring units are recurring units R_{PAEK} of formula J′-A.

In an embodiment, more than 75% by moles, typically more than 85% by moles, more typically more than 95% by moles, still more typically more than 99% by moles of the recurring units of the PEEK polymer are recurring units of formula J′-A. In another embodiment, all the recurring units of the PEEK polymer are recurring units of formula J′-A.

For the purpose of the present invention, the term “PEKK polymer” is intended to denote any polymer of which more than 50% by moles of the recurring units are recurring units R_{PAEK} of formula J′-B.

In an embodiment, more than 75% by moles, typically more than 85% by moles, more typically more than 95% by moles, still more typically more than 99% by moles of the recurring units of the PEKK polymer are recurring units of formula J′-B. In an embodiment, all the recurring units of the PEKK polymer are recurring units of formula J′-B.

The PAEK polymer may be characterized by intrinsic viscosity (IV), which may be measured using known methods and instrumentation. For examples, the measurement can be performed using a No. 50 Cannon-Fleske viscometer and is measured at 25° C. in a time less than 4 hours after dissolution.

In some embodiments, the intrinsic viscosity (IV) of the PAEK polymer is at least 0.50 dl/g, typically at least 0.60 dl/g, more typically at least 0.70 dl/g, as measured in 95-98% sulfuric acid (d=1.84 g/ml) at a PAEK polymer concentration of 0.1 g/100 ml.

In some embodiments, the IV of the PAEK polymer is equal to or less than 1.40 dl/g, typically equal to or less than 1.30 dl/g, more typically equal to or less than 1.20 dl/g, most typically equal to or less than 1.15 dl/g, as measured in 95-98% sulfuric acid (d=1.84 g/ml) at a (PAEK) polymer concentration of 0.1 g/100 ml.

The PAEK polymer may comprise a blend of PAEK polymers. For example, the PAEK polymer may comprise a blend of two or more different PAEK polymers or two or more of the same PAEK polymer, but of different grade. For instance, a blend may comprise two or more of the same PAEK polymer, each distinguishable by melt viscosity. Herein, melt viscosity is measured using a capillary rheometer in accordance with ASTM D3835. An exemplary capillary rheometer is a Kayeness Galaxy V Rheometer (Model 8052 DM).

In some embodiments, the PAEK polymer has a melt viscosity of at least 0.05 kPa·s, typically at least 0.08 kPa·s, more typically at least 0.1 kPa·s, still more typically at least 0.12 kPa·s, at 400° C. and a shear rate of 1000 s⁻¹, as measured using a capillary rheometer in accordance with ASTM D3835.

In some embodiments, the PAEK polymer has a melt viscosity of at most 1.00 kPa·s, typically at most 0.80 kPa·s, more typically at most 0.70 kPa·s, even more typically at most 0.60 kPa·s, most typically at most 0.50 kPa·s, at 400° C. and a shear rate of 1000 s⁻¹, as measured using a capillary rheometer in accordance with ASTM D3835.

PAEK polymers suitable for use in the composition may be prepared by any method known to those of ordinary skill or obtain commercially. For example, suitable PAEK polymers include the KETASPIRE® polyetheretherketone commercially available from Solvay Specialty Polymers USA, LLC.

Suitable polyarylene sulfides (PAS) are polymers in which more than 5 mol % of the recurring units are recurring units R_{PAS} represented by the formula

-Ar-S—,

wherein the Ar group denotes an optionally substituted arylene group, such a phenylene or a naphthylene group, which is linked by each of its two ends to two sulfur atoms (forming thus sulfide groups) via a direct C—S linkage.

In an embodiment, Ar at each occurrence is an optionally substituted p-phenylene, resulting in recurring units having the structure

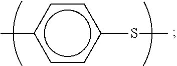

or an optionally substituted m-phenylene, resulting in recurring units having the structure

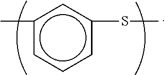

The arylene group Ar may be substituted by one or more substituents, including but not limited to, halogen atoms, C₁-C₁₂ alkyls, C₇-C₂₄ alkylaryls, C₇-C₂₄ aralkyls, C₆-C₁₈ aryls, C₁-C₁₂ alkoxy groups, and C₆-C₁₈ aryloxy groups. In an embodiment, Ar is unsubstituted.

The polyarylene sulfide typically comprises more than 25 mol %, more typically more than 50 mol %, and still more typically more than 90 mol % of recurring units R_{PAS}. In an embodiment, the polyarylene sulfide contains no recurring unit other than R_{PAS}.

In an embodiment, the polyarylene sulfide is polyphenylene sulphide, i.e. Ar is a pPh group, or p-phenylene group.

Suitable polyarylene sulfides may be produced according to methods known to those of ordinary skill in the art or obtained from commercial sources. For example, suitable polyarylene sulfides are available under the trade name RYTON® from Solvay Specialty Polymers USA, LLC.

The at least one thermoplastic polymer may be present as neat polymer or present as part of a polymer blend with one or more additional thermoplastic polymers.

Component b) is a small molecule organic salt, typically an aromatic salt. As used herein, an aromatic salt is the neutralization product of an aromatic acid, such as aromatic carboxylic acid or aromatic sulfonic acid, and a base, typically alkali metal or alkaline earth metal base. The aromatic salt is generally derived from aromatic compounds that comprise one-, two-, or three-ring hydrocarbon systems, such as benzene, naphthalene, anthracene, thiophene, and the like, as well as substituted derivatives of all these compounds. In an embodiment, the at least one small molecule organic salt is an aromatic carboxylic acid salt or an aromatic sulfonic acid salt.

Exemplary aromatic carboxylic acid salts include, but are not limited to, benzoic acid, hydroxybenzoic acid, aminobenzoic acid, methylbenzoic acid, nitrobenzoic acid, and isomers thereof. Exemplary aromatic sulfonic acid salts include, but are not limited to, benzenesulfonic acid, 4-hydroxybenzenesulfonic acid, 3-aminobenzenesulfonic acid, aniline-2-sulfonic acid, sulfanilic acid, 3-amino-4-hydroxybenzenesulfonic acid, 2,4-diaminobenzenesulfonic acid, 2,5-diaminobenzenesulfonic acid, and isomers thereof. In some embodiments, the at least one small molecule organic salt is a benzoic acid salt or a benzenesulfonic acid salt.

The small molecule organic salts are generally alkali metal salts, such as sodium, lithium, and potassium salts; alkaline earth metal salts, such as magnesium, calcium, strontium, and barium salts; or ammonium salts In an embodiment, the at least one small molecule organic salt is a benzoic acid sodium salt or a benzenesulfonic acid sodium salt, more typically a benzenesulfonic acid sodium salt.

Component c) is a water-soluble or water-dispersible polymer. Any water-soluble or water-dispersible polymer known to those of ordinary skill may be used. However, the at least one water-soluble or water-dispersible polymer is typically the salt of a sulfonated aromatic polymer.

In an embodiment, the at least one water-soluble or water-dispersible polymer is typically the salt of a polycondensation product of an aromatic sulfonic acid with formaldehyde, more typically the salt of a polycondensation product of naphthalene sulfonic acid with formaldehyde.

In an embodiment, the at least one water-soluble or water-dispersible polymer comprises a recurring unit R_{NSP} represented by the structure

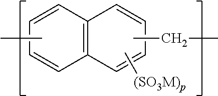

wherein
M is an monovalent cation, typically alkali metal cation; and
p is a value from 0.5 to 6.

In an embodiment, M is a monovalent selected from the group consisting of lithium, sodium, potassium, ammonium, and substituted ammonium ions derived from organic amines, quaternary ammonium ions. In an embodiment, M is an alkali metal cation, typically selected from the group consisting of lithium, sodium, and potassium.

As indicated in the recurring unit R_{NSP}, the exact position or orientation of the methylene (—CH₂—) linkages on the aromatic rings is not known and is generally recognized as being complex and varied. It is understood that some of the formaldehyde linkages may not be solely of the —CH₂-type but can also involve some extended units, such as CH₂OCH₂ and CH₂(OCH₂)OCH₂, or other possibilities, although the formaldehyde linkages are believed to consist essentially of the methylene linkage depicted in structure of recurring unit R_{NSP}.

The value p refers to the degree of sulfonation (D.S.), defined herein as the average number of sulfonate or sulfonic acid groups per repeat unit of the polymeric structure, and may be a value from 0.5 to 6. Commercially available sulfonated polymers are typically prepared by condensation of formaldehyde with naphthalene sulfonic acid and therefore have a degree of sulfonation of essentially 1. However, the composition of the present disclosure is not limited to the use of such commercially available polymers, but includes analogous formaldehyde/naphthalene condensation products wherein the degree of sulfonation is other than 1. In those embodiments wherein p is other than 1, the water-soluble or water-dispersible polymer comprising the recurring unit R_{NSP} is generally prepared by aromatic sulfonation of naphthalene formaldehyde condensation polymer precursors, which are prepared by heating approximately equimolar quantities of formaldehyde and naphthalene in an inert solvent, in the presence of an acid catalyst such as sulfuric acid, p-toluenesulfonic acid, methanesulfonic acid, or perchloric acid, for several hours. Sulfonation agents, such as anhydrous sulfur trioxide, triethyl phosphate (TEP) complexes of sulfur trioxide, and chlorosulfonic acid, are then used in suitable solvents, such as methylene chloride, 1,2-dichloroethane, and chloroform, to achieve the desired sulfonation reaction.

The amounts of components a), b), and c) in the composition is not particularly limited. However, in an embodiment, the composition suitably comprises:
a) 30 to 50 wt % of the at least one thermoplastic polymer,
b) 25 to 35 wt % of the at least one small molecule organic salt, and
c) 25 to 35 wt % of the at least one water-soluble or water-dispersible polymer, relative to the weight of the composition.

In an embodiment, the total amount of the at least one small molecule organic salt and the at least one water-soluble or water-dispersible polymer is greater than or less than 55 wt %, relative to the weight of the composition.

In another embodiment, the amount of the at least one thermoplastic polymer is less than or equal to 40 wt %, relative to the weight of the composition.

In some embodiments, the composition may further optionally comprise an additive or a filler. Exemplary additives include, but are not limited to, ultraviolet light stabilizers, heat stabilizers, antioxidants, pigments, processing aids, lubricants, flame retardants, and/or conductivity additive such as carbon black and carbon nanofibrils. Exemplary fillers, for example, reinforcing fillers or mineral fillers, may be selected from the group consisting of glass fibers, carbon fibers, talc, wollastonite, calcium carbonate, mica, and the like.

The composition may further comprise a water-soluble or water-dispersible polymer different from the at least one water-soluble or water-dispersible polymer. In an embodiment, the composition further comprises a polyester polymer.

Suitable polyester polymers are polymers that comprise units from:
at least one dicarboxylic acid component, and
at least one diol component, wherein at least 2 mol. % of the diol component is a poly(alkylene glycol) of formula (I):

H(O—CₘH₂ₘ)ₙ—OH,

wherein m is an integer from 2 to 4, and n varies from 2 to 10.

In an embodiment, the dicarboxylic acid component comprises at least one aromatic dicarboxylic acid, typically selected from the group consisting of isophthalic acid (IPA), terephthalic acid (TPA), naphthalenedicarboxylic acids (e.g. naphthalene-2,6-dicarboxylic acid), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, and mixtures thereof.

In an embodiment, the diol component is such that at least 2 mol. % of the diol component is a poly(ethylene glycol) of formula (II):

H(O—CH₂—CH₂)ₙ—OH,

wherein n varies from 2 to 10.

In an embodiment, the diol component is such that at least 4 mol. %, at least 10 mol. %, at least 20 mol. %, at least 30 mol. %, at least 40 mol. % or at least 50 mol. % of the diol component (based on the total number of moles of the diol component) is a poly(alkylene glycol) of formula (I):

H(O—CₘH₂ₘ)ₙ—OH,

wherein m is an integer from 2 to 4, and n varies from 2 to 10,
typically a poly(ethylene glycol) of formula (II):

H(O—CH₂—CH₂)ₙ—OH,

wherein n varies from 2 to 10.

In an embodiment, the diol component is such that at least 2 mol. %, at least 4 mol. %, at least 10 mol. %, at least 20 mol. %, at least 30 mol. %, at least 40 mol. % or at least 50 mol. % of the diol component (based on the total number of moles of the diol component), is a diethylene glycol of formula HO—CH₂—CH₂—O—CH₂—CH₂—OH.

In another embodiment, apart from the 2 mol. % minimal content of poly(alkylene glycol), the diol component may comprise at least one diol selected from the group consisting of ethylene glycol, 1,4-cyclohexanedimethanol, propane-1,2-diol, 2,2-dimethyl-1,3-propanediol, 1,3-propanediol, 1,4-butanediol, 1,5-pentanediol, 1,6-hexanediol, 2-methyl-1,5-pentanediol, isosorbide and 2,5-bishydroxymethyltetrahydrofuran.

In an embodiment, the diol component of the polyester polymer consists essentially of:
a diol selected from the group consisting of ethylene glycol, 1,4-cyclohexanedimethanol, propane-1,2-diol, 2,2-dimethyl-1,3-propanediol, 1,3-propanediol, 1,4-butanediol, 1,5-pentanediol, 1,6-hexanediol, 2-methyl-1,5-pentanediol, isosorbide and 2,5-bishydroxymethyltetrahydrofuran,
at least 2 mol. % of poly(ethylene glycol) having a formula (I):

H(O—CH₂—CH₂)ₙ—OH,
wherein n varies from 2 to 10.

In another embodiment, the diol component of the polyester polymer consists essentially of:
a diol selected from the group consisting of ethylene glycol, 1,4-cyclohexanedimethanol, propane-1,2-diol, 2,2-dimethyl-1,3-propanediol, 1,3-propanediol, 1,4-butanediol, 1,5-pentanediol, 1,6-hexanediol, 2-methyl-1,5-pentanediol, isosorbide and 2,5-bishydroxymethyltetrahydrofuran,
at least 2 mol. % of diethylene glycol (based on the total number of diol components).

In an embodiment, the polyester polymer further comprises recurring units from a difunctional monomer containing at least one SO₃M group attached to an aromatic nucleus, wherein the functional groups are carboxy and wherein M is H or a metal ion selected from the group consisting of sodium, potassium, calcium, lithium, magnesium, silver, aluminium, zinc, nickel, copper, palladium, iron, and cesium, typically from the group consisting of sodium, lithium and potassium. Such polyesters are sometimes called sulfopolyesters (SPE).

In an embodiment, the difunctional sulfomonomer can, for example, be present in the SPE in a molar ratio comprised between 1 to 40 mol. %, based on the total number of moles (i.e. total number of moles of diacid and diol components if the SPE is composed exclusively of diacid and diol components) in the SPE, for example between 5 and 35 mol. %, or between 8 to 30 mol. %.

In an embodiment, the polyester comprises units from:
at least one dicarboxylic acid component,
at least one diol component, wherein at least 2 mol. % of the diol component is a poly(alkylene glycol) of formula (I):

H(O—CₘH₂ₘ)ₙ—OH,
wherein m is an integer from 2 to 4 and n varies from 2 to 10;
at least one difunctional monomer containing at least one SO₃M group attached to an aromatic nucleus, wherein the functional groups are carboxy and wherein M is H or a metal ion selected from the group consisting of sodium, lithium and potassium.

In another embodiment, the polyester comprises units from:
at least one aromatic dicarboxylic acid component,
at least one diol component,
at least 1 mol. % (based on the total number of units moles in the polyester polymer, e.g. total number of diacid and diol components if the polyester is composed exclusively of diacid and diol units) of poly(alkylene glycol) of formula (I):

H(O—CₘH₂ₘ)ₙ—OH,
wherein m is an integer from 2 to 4 and n varies from 2 to 10, typically m equals 2 and n equals 2;
at least one aromatic dicarboxylic acid containing at least one SO₃M group attached to an aromatic nucleus, wherein M is H or a metal ion selected from the group consisting of sodium, lithium and potassium.

In an embodiment, the polyester comprises or consists essentially in units from:
an aromatic dicarboxylic acid selected from the group consisting of isophthalic acid (IPA), terephthalic acid (TPA), naphthalenedicarboxylic acids (e.g. naphthalene-2,6-dicarboxylic acid), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene and mixture thereof, typically isophthalic acid;
a diol selected from the group consisting of ethylene glycol, 1,4-cyclohexanedimethanol, propane-1,2-diol, 2,2-dimethyl-1,3-propanediol and mixture thereof;
at least 1 mol. % (based on the total number of units moles in the polyester, e.g. total number of diacid and diol components if the polyester is composed exclusively of diacid and diol units) of diethylene glycol;
an aromatic dicarboxylic acid (e.g. isophthalic acid, terepthalic acid, 2,6-naphthalene dicarboxylic acid) containing at least one SO₃M group attached to an aromatic nucleus, wherein M is H or a metal ion selected from the group consisting of sodium, lithium and potassium.

In an embodiment, the polyester comprises at least 2 mol. %, at least 4 mol. %, at least 10 mol. %, at least 20 mol. %, at least 30 mol. %, at least 40 mol. % or at least 50 mol % of diethylene glycol, based on the total number of units moles in the polyester, e.g. total number of diacid and diol components if the polyester is composed exclusively of diacid and diol units.

Suitable polyester polymers are available as AQ™ Polymers, such as AQ 48 Ultra (Polyester-5), available from Eastman.

The at least one thermoplastic polymer may be characterized by a melt flow rate. The melt flow rate may be measured using methods and means known to those of ordinary skill in the art. Herein, the melt flow rate is measured according to ASTM D1238 at 400° C. under a weight of 2.16 kg. In an embodiment, the at least one thermoplastic polymer has a melt flow rate of from 3 to 36 g/min.

The second aspect of the present disclosure relates to a process for preparing particles comprising a thermoplastic polymer, wherein the particles have an average size of less than 2 μm, typically less than 1 μm, such as 0.1 to 1 μm, the process comprising:
a) melt-blending the composition described herein,
b) processing the melt-blended composition obtained in step a) into pellets or strands,
c) cooling the pellets or strands obtained in step b),
d) contacting the cooled pellets or strands obtained in step c) with water, typically hot water, more typically water at a temperature of from 50 to 100° C., thereby forming the particles comprising the thermoplastic polymer.

The process is based on the melt-blending of the thermoplastic polymer with a water-soluble or water dispersible polymer, in such a way as to create particles of thermoplastic polymer dispersed in a phase made of the water-soluble or water-dispersible polymer, for example by applying a mixing energy sufficient to create discrete particles. The blend is then cooled down and the particles are recovered by dissolution or dispersion of the water-soluble or water-dispersible polymer in water, optionally at a temperature of from 50 to 100° C.

Melt-blending the composition described herein can take place with any suitable device, such as endless screw mixers or stirrer mixers, for example compounder, compatible with the temperature needed to melt the thermoplastic polymer. The step of melt-blending generally takes place at a temperature above 280° C., for example above 290° C., for example above 300° C., above 310° C.

Step b) of processing the mixture into pellets or strands can be carried out according to methods and means known to those of ordinary skill in the art. For example, processing the mixture into pellets or strands can be carried out by a process of extrusion through a die. Accordingly, this can be achieved using an extruder equipped with an extrusion die.

The step of cooling, step c), is conducted by any appropriate means, at a temperature lower than 80° C., for example lower than 50° C. Mention can notably be made of air cooling or quenching in a liquid, for example in water.

Step d) of contacting the pellets or strands with water may be conducted according to methods and means known to those of ordinary skill in the art. For example, the pellets or strands may be immersed in water, possibly multiple baths of water, which may optionally be heated. This step allows dissolution of the water-soluble or water-dispersible polymer so as to recover the thermoplastic particles. Advantageously, no acid or base is needed for the dissolution or dispersion of the water-soluble or water-dispersible polymer.

The steps of the process can be carried out batch-wise or continuously.

In an embodiment, the steps of cooling the pellets or strands and contacting said pellets or strands with water, for example by immersion of the pellets or strands into water, is carried out simultaneously on the same equipment.

The process may further comprise drying and/or sieving the particles comprising the thermoplastic polymer. The step of drying can, for example, take place in a fluidized bed.

As would be apparent from the present disclosure, the process provides the advantage that particles of very small size, such as an average size of less than 2 μm, typically less than 1 μm, such as 0.1 to 1 μm, can be made without the use of mechanical grinding steps. Thus, in an embodiment, the process is free of any grinding steps. Herein, the size of the particles made according to the process measurements are obtained by Scanning Electron Microscopy (SEM). Generally, the powders obtained are dispersed onto carbon-tape affixed to an aluminum stub, and then sputter-coated with AuPd using a sputter coater. Images are recorded using SEM and images are analyzed for average diameter using known imaging software on approximately 20 particle images.

The particles obtained by the process are advantageously of high purity, typically greater than 90% pure, more typically greater than 95% pure, still more typically greater than 98% pure. In an embodiment, the particles obtained by the process is greater than 99% pure. Purity can be determined using a Thermogravimetric Analysis (TGA) method. TGA scans of the polymer starting material and each isolated powder sample are taken and the purity is calculated by the ratio of weight loss of the powder to the weight loss of the starting polymer at 450° C. (times 100%).

Other than an average size of less than 2 μm, typically less than 1 μm, such as 0.1 to 1 μm, the particles obtained from the process described herein may be characterized by BET surface area. The BET surface area may be measured using methods and equipment well-known to those of ordinary skill in the art. The particles comprising the thermoplastic polymer prepared by the process described herein have BET surface area of from 5 to 15 m²/g, typically from 5 to 8 m²/g.

The third aspect of the present disclosure relates to a collection of particles prepared according to the process described herein. As mentioned hereinabove, the particles each comprising at least one thermoplastic polymer have an average size of less than 2 μm, typically less than 1 μm, such as 0.1 to 1 μm, and a BET surface area of from 5 to 15 m²/g, typical from 5 to 8 m²/g.

The fourth aspect of the present disclosure relates to a dispersion comprising a collection of particles described herein, at least one surfactant, and a liquid medium.

The surfactant may be any surfactant known to those of ordinary skill, including, but not limited to, anionic surfactants, cationic surfactants, non-ionic surfactants, amphoteric surfactants, zwitterionic surfactants, and combinations thereof. In an embodiment, the surfactant is a non-ionic surfactant.

Exemplary, non-limiting classes of useful nonionic surfactants include poly(alkylene oxide)-containing compounds, such as alkoxylated alkyl phenols and alkoxylated linear or branched alcohols; fatty acid esters, amines and amide derivatives, alkylpolyglucosides, and combinations thereof. In an embodiment, the at least one surfactant is a poly(alkylene oxide)-containing non-ionic surfactant.

Alkoxylated alkyl phenols are generally the polyethylene, polypropylene, and/or polybutylene oxide condensates of alkyl phenols. Such compounds include the condensation products of alkyl phenols having an alkyl group containing from about 6 to about 12 carbon atoms in either a straight chain or branched chain configuration with the alkylene oxide, typically ethylene oxide, propylene oxide, and/or butylene oxide. Commercially available nonionic surfactants of this type include alkyl phenol ethoxylates available in the IGEPAL® line from Solvay.

Alkoxylated linear or branched alcohols are the condensation products of aliphatic linear or branched alcohols with from about 1 to about 25 moles of ethylene oxide, propylene oxide, and/or butylene oxide, typically ethylene oxide. The aliphatic chain of the alcohol can either be linear or branched, and generally contains from about 8 to about 22 carbon atoms. Examples of commercially available nonionic surfactants of this type include TERGITOL® 15-S-9 (the condensation product of C11-C15 linear secondary alcohol with 9 moles ethylene oxide) and TERGITOL® MIN FOAM 1× (the condensation product of a C4 linear primary alcohol with ethylene oxide and propylene oxide) marketed by DOW.

The amounts of particles and surfactant in the dispersion are not particular limited. However, in an embodiment, the dispersion comprises up to 40 wt % of the collection of particles and up to 10 wt %, typically up to 5 wt %, of the surfactant, relative to the total weight of the dispersion.

The liquid medium of the dispersion comprises water and may further comprise one or more organic solvents that are miscible with water. Exemplary water-miscible organic solvents, include, for example, acetone, acetonitrile, 1,2-butanediol, 1,3-butanediol, 1,4-butanediol, 2-butoxyethanol, diethanolamine, diethylenetriamine, dimethylformamide (DMF), dimethoxyethane, dimethyl sulfoxide (DMSO), 1,4-dioxane, ethanol, ethylamine, ethylene glycol, furfuryl alcohol, glycerol, methanol, methyl diethanolamine, methyl isocyanide, N-methyl-2-pyrrolidone, 1-propanol, 1,3-propanediol, 1,5-pentanediol, 2-propanol, propylene glycol, pyridine, tetrahydrofuran (THF), triethylene glycol, and the like. In an embodiment, the liquid medium of the dispersion consists or consists essentially of water.

The fifth aspect of the present disclosure relates to a process for preparing the dispersion described herein. The process for preparing the dispersion comprises mixing a collection of particles prepared according to a process described herein or a collection of particles each comprising at least one thermoplastic polymer, wherein the particles have an average size of less than 2 μm, typically less than 1 μm, such as 0.1 to 1 μm, and a BET surface area of from 5 to 15 m²/g, typical from 5 to 8 m²/g, with at least one surfactant, and a liquid medium.

The mixing of the particles, surfactant, and the liquid medium may be achieved using any methods and means known to those of ordinary skill in the art. In a suitable method, a surfactant and liquid medium, typically water, is combined in a vessel equipped with an overhead stirrer and mixing blade. The collection of particles in the form of powder is slowly added to the liquid medium/surfactant mixture at 500 rpm, and the stirring rate is increased to 800 rpm as addition is completed. The dispersion is allowed to mix for a time and then removed from the stirring vessel and poured into a disperser with a single-stage dispersing blade capable of high stirring rate, such as 20,000 rpm, and dispersed for a time.

The compositions, methods, and processes according to the present disclosure are further illustrated by the following non-limiting examples.

### EXAMPLES

The dispersible phase components and particle phase components used in the following examples are summarized in Tables 1 and 2, respectively, below.

TABLE 1

| | | Molecular | | |
|---|---|---|---|---|
| Dispersible Phase | | Weight | Tm 1 | Tm 2 |
| Components | CAS# | (g/mol) | (° C.) | (° C.) |
| Sodium naphthalenesulfonate | 9084-06-4 | 1200 | 250 | — |
| polymer (NaNSP) - Parchem | | | | |
| Sodium benzenesulfonate | 515-42-4 | 180.2 | 320 | 418 |
| (NaBzS) - Biddle Sawyer | | | | |
| Sodium benzoate (NaBz) - | 532-32-1 | 144.1 | 442 | 463 |
| Fluid Energy | | | | |

TABLE 2

| | Molecular | |
|---|---|---|
| | Weight | Tm |
| Particle Phase Components | (g/mol) | (° C.) |
| KetaSpire ® KT-820P [MV (400° C., 1000 s⁻¹) | >10,000 | 343 |
| ranges from 0.12-0.18 kPa · s; IV is 0.75 | | |
| dl/g-0.77 dl/g] - aromatic PEEK polymer | | |
| KetaSpire ® KT-880P [MV (400° C., 1000 s⁻¹) | >10,000 | 343 |
| ranges from 0.38-0.50 kPa · s] - aromatic | | |
| PEEK polymer | | |
| Ryton ® QC160N - PPS polymer | >10,000 | 280 |
| Xydar ® SRT-900 - LCP polymer | >10,000 | 350 |

### Example 1. Production of Sub-Micron Thermoplastic Particles

Compounding: Compounds of the desired particle phase components and dispersible phase components were made by blending the components in a Coperion ZSK-26 twin screw extruder (Coperion GmbH, Stuttgart, Germany). This extruder had 12 barrel zones and a heated exit die operating at up to 450° C. and was capable of mass throughputs >30 kg/hour.

A K-TronT-35 gravimetric feeder (Coperion GmbH, Stuttgart, Germany) was used to feed each material into the feeding section(s) of the extruder to yield the proper mass ratio of the components. The components were melted and mixed with screws designed to achieve a homogeneous melt composition. The actual melt temperature at the exit die was measured with a hand-held device for each compound.

The melt stream was air cooled on a conveyor and fed into a Maag Primo 60E pelletizer (Maag Automatik GmbH, Stuttgart, Germany) to pelletize. For blends that were too brittle to pelletize, raw strands were collected into a bucket or drum at the end of the conveyor. Mass production rates were 17.5 kg per hour. The pellets or strands were kept in sealed plastic buckets until used further use. The processing conditions for PEEK compounds are summarized in Table 3 below and the processing conditions for PPS and LCP compounds are summarized in Table 4 below.

TABLE 3

| | KT- | | | | | Screw | | Melt |
|---|---|---|---|---|---|---|---|---|
| | 820P:KT- | | | | | speed | | Temp |
| Ex. | 880P ratio | % PEEK | % NaNSP | % NaBzS | % NaBz | (rpm) | Torque | (° C.) |
| 1 | 100/0 | 50 | 25 | 25 | — | 150 | 55 | 379 |
| 2 | 100/0 | 50 | 25 | 25 | — | 200 | 35 | 376 |
| 3 | 100/0 | 45 | 25 | 30 | — | 200 | 24 | 373 |
| 4 | 100/0 | 40 | 30 | 30 | — | 200 | 26 | 376 |
| 5 | 0/100 | 40 | 30 | 30 | — | 150 | 30 | 368 |
| 6 | 0/100 | 30 | 35 | 35 | — | 150 | 68 | 366 |
| C1 | 100/0 | 50 | 25 | — | 25 | 150 | 53 | 380 |
| C2 | 0/100 | 40 | 30 | — | 30 | 150 | 48 | 362 |
| 7 | 65/35 | 40 | 30 | 30 | | 200 | 28 | 373 |
| 8 | 50/50 | 30 | 35 | 35 | | 200 | 27 | 372 |
| 9 | 50/50 | 40 | 30 | 30 | | 200 | 27 | 371 |

TABLE 4

| | | | | | | Screw | | Melt |
|---|---|---|---|---|---|---|---|---|
| | | | | | | speed | | Temp |
| Ex. | Polymer | % Polymer | % NaNSP | % NaBzS | % NaBz | (rpm) | Torque | (° C.) |
| C3 | QC160N | 40 | 30 | — | 30 | 150 | 38 | 341 |
| C4 | QC160N | 40 | 30 | 30 | — | 150 | 42 | 342 |
| 10 | QC160N | 30 | 35 | 35 | — | 150 | 52 | 340 |
| 11 | SRT-900 | 30 | 35 | 35 | — | 200 | 40 | 350 |
| 12 | SRT-900 | 25 | 37.5 | 37.5 | — | 200 | 41 | 352 |

Particle Isolation and Washing: Strands or pellets of each LCP, PPS or PEEK compound were placed in hot water to dissolve the soluble components and either particles or a porous solid was obtained. Particle samples were isolated by filtration and washed with water to remove excess dispersible phase materials.

Generally, 50/50 mixture of strands from the examples above were made with water (e.g., 500 g strands to 500 g water) in a stainless steel container with mixing from an overhead stirrer equipped with a steel mixing blade. The mixture was heated with a hot plate to 80° C. at approximately 500-700 rpm and held at temperature for 1-2 hours. The mixture was poured into a 250 mm diameter Buchner funnel with a Whatman GF6 glass fiber filter and allowed to stand for approximately 10 minutes. House vacuum was then applied and all liquid was removed, leaving a fine filter cake. The filter cake was removed from filter paper and dispersed in water at room temperature, after which it was filtered again. Washing and filtration steps were repeated until a high purity powder (>98%) was obtained. The powders were dried under vacuum at 50° C.

In some comparative examples, it was observed that a porous solid was obtained. No further characterization of the porous solids were conducted.

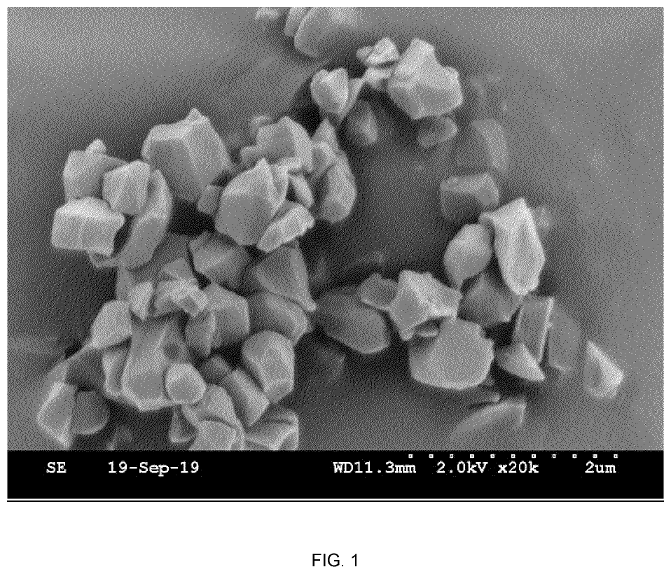

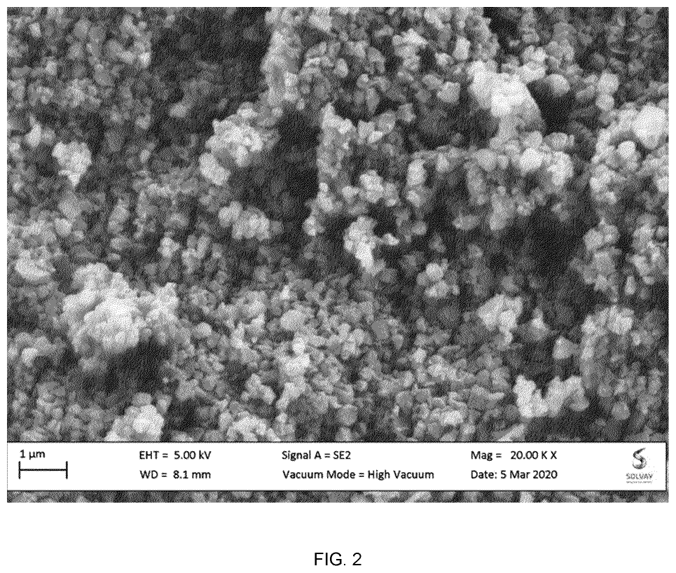

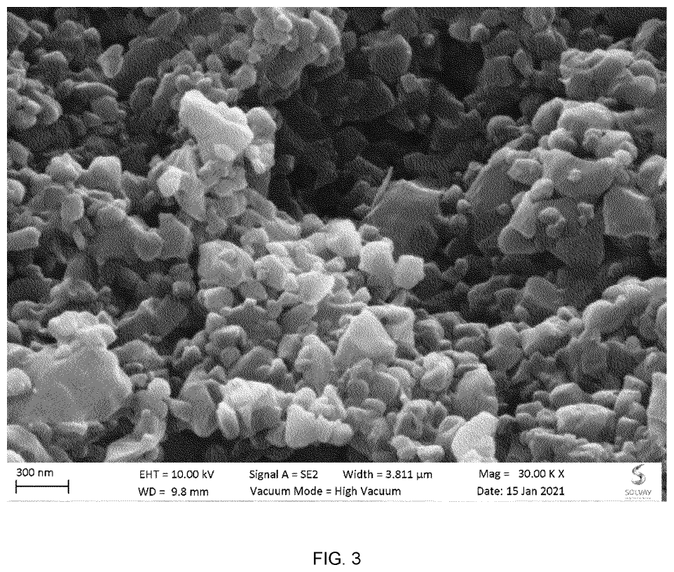

Particle size measurements were obtained by Scanning Electron Microscopy (SEM). SEM measurements were accomplished as follows. Powders were dispersed onto carbon-tape affixed to aluminum stub, and then sputter-coated with AuPd using an Emitech K575x Turbo Sputter Coater. Images were recorded using a Hitachi S-4300 Cold Field Emission Scanning Electron Microscope and images were analysed for average diameter using ImageJ v 1.49b Java-Based Image Analysis Software on approximately 20 particle images. SEM images of the PEEK, PPS, and LCP polymer particles, respectively, are shown in FIG. 1-3. As shown in FIG. 1-3, the particles produced have a substantially irregular shape.

Purity analysis was conducted using a Thermogravimetric Analysis (TGA) method. TGA scans of the polymer starting material and each isolated powder sample are taken on a TA Instruments Thermal Analyzer at 20° C./minute in nitrogen. The purity is calculated by the ratio of weight loss of the powder to the weight loss of the starting polymer at 450° C. (times 100%). The results for the PEEK, LCP, and PPS polymers are summarized in Table 5 below.

TABLE 5

| Sample | Solid form | Powder purity (%) | Particle size, SEM (μm) |
|---|---|---|---|
| 1 | powder | >99 | 0.73 |
| 2 | powder | >99 | 0.67 |
| 3 | porous | — | — |
| | solid | | |
| 4 | powder | >99 | 0.73 |
| 5 | powder | >99 | 0.32 |
| 6 | powder | >99 | 0.23 |
| C1 | porous | — | — |
| | solid | | |
| C2 | porous | — | — |
| | solid | | |
| 7 | powder | >99 | 0.50 |
| 8 | powder | >99 | 0.47 |
| 9 | powder | >99 | 0.41 |
| C3 | porous | — | — |
| | solid | | |
| C4 | porous | — | — |
| | solid | | |
| 10 | powder | >98 | 0.19 |
| 11 | powder | >92 | 0.24 |
| 12 | powder | >94 | 0.23 |

### Example 2. Production of Dispersions

Aqueous particle dispersions were made from the particles of Samples 2 and 5 produced according to Example 1.

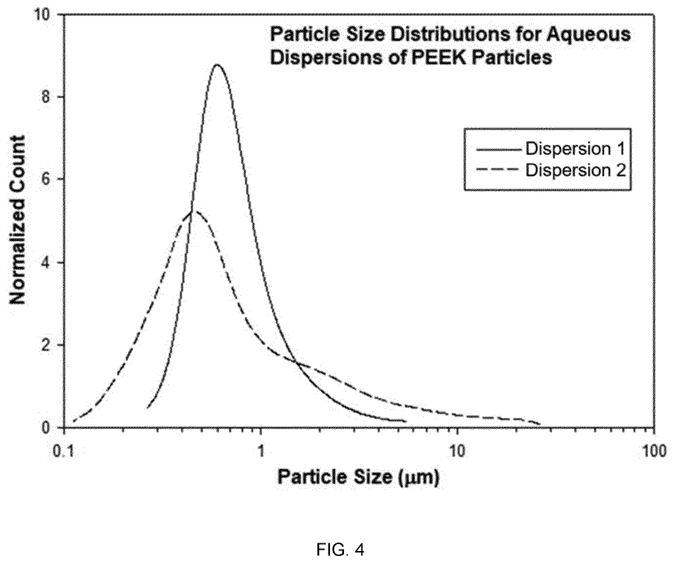

A mixture with 22% total solids was made by adding 4% TERGITOL™ Min Foam 1× Surfactant to water in a stainless steel container equipped with an overhead stirrer and mixing blade. Dry powder sample was slowly added to the water/surfactant mixture at 500 rpm, increasing the stirring rate to 800 rpm as addition was completed. The final composition of the PEEK powder was 18% by weight. Each sample was allowed to mix for 1 hour. The samples were then removed from the stirring vessel and poured into an IKA Magic LAB® disperser with a single-stage dispersing blade at 20,000 rpm. The samples were recirculated through the disperser for 30 minutes while employing circulator/chiller loop to control the temperature to 50° C. Samples were removed from the disperser and allowed to cool to room temperature. Particle size analysis (PSA) was conducted using a Microtrac S3500 with Microtrac Sample Delivery Controller (SDC). Particle size distributions for the dispersions made is shown in FIG. 4 and the results for D10, D50, and D90 are tabulated in Table 6 below. As would be understood by a person of ordinary skill in the art, D90 or D(v, 0.9) is the size of particle below which 90% of the sample lies. D50 or D(v, 0.5) is the size in microns at which 50% of the sample is smaller and 50% is larger. Similarly, D10 or D(v, 0.1) is the size of particle below which 10% of the sample lies.

As used herein, the particle size distribution refers to volume distribution, unless otherwise stated. Samples of the aqueous dispersions prepared as described above were measured directly on the Microtrac S3500.

TABLE 6

| | | Avg. | | | | |
|---|---|---|---|---|---|---|
| | | particle | Dispersion | | | |
| | Particle | size, | time | Particle size (μm) | | |
| Dispersion | Sample | SEM (μm) | (min.) | D10 | D50 | D90 |
| 1 | 2 | 0.73 | 30 | 0.40 | 0.64 | 1.4 |
| 2 | 5 | 0.32 | 30 | 0.24 | 0.54 | 2.9 |

1. A composition comprising:
a) at least one thermoplastic polymer,
b) at least one small molecule organic salt, and
c) at least one water-soluble or water-dispersible polymer.

2. The composition according to claim 1, wherein the at least one thermoplastic polymer is selected from the group consisting of liquid crystal polymers (LCP), polyamides (PA), polyimides (PI), polyarylether ketones (PAEK), polyamide-imides (PAI), polyarylene sulfides (PAS), polyarylether sulfones (PAES), fluoropolymers (FP), and combinations thereof.

3. The composition according to claim 1, wherein the at least one thermoplastic polymer is selected from the group consisting of liquid crystal polymers (LCP); polyarylether ketones (PAEK); polyarylene sulfides (PAS); and combinations thereof.

4. The composition according to claim 1, wherein the at least one small molecule organic salt is an aromatic salt.

5. The composition according to claim 1, wherein the at least one small molecule organic salt is a benzoic acid salt or a benzenesulfonic acid salt.

6. The composition according to claim 1, wherein the at least one water-soluble or water-dispersible polymer is the salt of a sulfonated aromatic polymer.

7. The composition according to claim 1, wherein the at least one water-soluble or water-dispersible polymer comprises a recurring unit represented by the structure 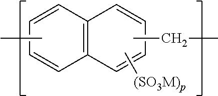
wherein
M is a monovalent cation; and
p is a value from 0.5 to 6.

8. The composition according to claim 1, wherein the composition comprises:
a) 30 to 50 wt % of the at least one thermoplastic polymer,
b) 25 to 35 wt % of the at least one small molecule organic salt, and
c) 25 to 35 wt % of the at least one water-soluble or water-dispersible polymer, relative to the weight of the composition.

9. The composition according to claim 1, further comprising an additive or a filler.

10. The composition according to claim 1, further comprising a water-soluble or water-dispersible polymer different from the at least one water-soluble or water-dispersible polymer.

11. The composition according to claim 1, wherein the total amount of the at least one small molecule organic salt and the at least one water-soluble or water-dispersible polymer is greater than or less than 55 wt %, relative to the weight of the composition.

12. The composition according to claim 1, wherein the amount of the at least one thermoplastic polymer is less than or equal to 40 wt %, relative to the weight of the composition.

13. The composition according to claim 1, wherein the at least one thermoplastic polymer has a melt flow rate of from 3 to 36 g/min at 400° C., 2.16 kg.

14. A process for preparing particles comprising a thermoplastic polymer, wherein the particles have an average size of less than 2 μm, the process comprising:
a) melt-blending a composition according to claim 1,
b) processing the melt-blended composition obtained in step a) into pellets or strands,
c) cooling the pellets or strands obtained in step b),
d) contacting the cooled pellets or strands obtained in step c) with water, thereby forming the particles comprising the thermoplastic polymer, and
e) optionally drying and/or sieving the particles comprising the thermoplastic polymer.

15. (canceled)

16. (canceled)

17. The process according to claim 14, wherein the particles comprising the thermoplastic polymer prepared have BET surface area of from 5 to 15 m²/g.

18. A collection of particles prepared according to claim 14.

19. A collection of particles each comprising at least one thermoplastic polymer, wherein the particles have an average size of less than 2 μm, and a BET surface area of from 5 to 15 m²/g.

20. A dispersion comprising a collection of particles according to claim 18, at least one surfactant, and a liquid medium.

21. The dispersion according to claim 20, wherein the surfactant is a non-ionic surfactant.

22. The dispersion according to claim 20, wherein the dispersion comprises up to 40 wt % of the collection of particles and up to 10 wt %, of the surfactant, relative to the total weight of the dispersion.

23. A process for preparing a dispersion, the process comprising mixing a collection of particles prepared according to claim 14 or a collection of particles each comprising at least one thermoplastic polymer, wherein the particles have an average size of less than 2 μm, and a BET surface area of from 5 to 15 m²/g, with at least one surfactant, and a liquid medium.
